(19) United States
(12) Patent Application Publication
(10) Pub. No.: US 2005/0031923 A1
(43) Pub. Date: Feb. 10, 2005

(54) Solid state electrolytic fuel cell

(76) Inventors: Masahiro Kuroishi, Fukuoka (JP); Hiroyuki Nagaiwa, Fukuoka (JP); Susumi Aikawa, Fukuoka (JP)

Correspondence Address: BIRCH STEWART KOLASCH & BIRCH, PO BOX 747, FALLS CHURCH, VA, 22040-0747, US

(21) Appl. No.: 10/488,465

(22) PCT Filed: Sep. 6, 2001
(86) PCT No.: PCT/JP01/07722

(51) Int. Cl. H01M 8/12; H01M 8/02

(52) U.S. Cl. 429/30; 429/34

(57) ABSTRACT

In a solid oxide fuel cell, plate-like current collecting members 6, which are divided (into four sections) in the cell axis direction, are provided at both ends of a cell stack 2. Current collecting rods 7a, 7b, 7c, 7d as a first current path extend from the current collecting member sections 6a, 6b, 6c, 6d respectively. These current collecting rods 7a, 7b, 7c, 7d are collected at a current collector 8, and electric current is withdrawn out of a bulkhead of a reaction chamber by a terminal 9 which extends from the current collector 8.

### TECHNICAL FIELD

This invention relates to a solid oxide fuel cell comprising cylindrical cells. More specifically, this invention relates to a solid oxide fuel cell comprising cylindrical cells in which improvements are introduced in a current collecting portion for withdrawing electric current from a reaction chamber, gas sealing property and insulating property are enhanced, and the cost is reduced by decreasing the number of components.

### BACKGROUND ART

A solid oxide fuel cell comprising cylindrical cells, which is one type of a solid oxide fuel cell, has been disclosed in Japanese Pre-grant Publication No. 1-59705. The solid oxide fuel cell comprises cylindrical cells each of which is comprised of a porous support tube, an air electrode, oxide, a fuel electrode, and an interconnection. When oxygen (air) is fed into the air electrode and gas fuel (H₂, CO and the like) is fed into the fuel electrode, O²⁻ ions move in the cell, which causes chemical combustion, and a potential difference is generated between the air electrode and the fuel electrode so as to produce electric power. Incidentally, another configuration is possible in which an air electrode functions as a support tube.

The material, the thickness, and the manufacturing method of a conventionally typical solid oxide fuel cell comprising cylindrical cells are as follows (Proc. of the 3^{rd} Int. Symp. On SOFC, 1993):
Support tube: ZrO₂ (CaO), Thickness 1.2 mm, Extrusion
Air electrode: La(Sr)MnO₃, Thickness 1.4 mm, Slurry coat
Oxide: ZrO₂ (Y₂O₃), Thickness 40 μm, EVD
Interconnection: La(Sr)MnO₃, Thickness 40 μm, EVD
Fuel electrode: Ni—ZrO₀₂ (Y₂O₃), Thickness 100 μm, Slurry coat-EVD

FIG. 4 shows the longitudinal section of the main part of the conventional solid oxide fuel cells and FIG. 5 shows the sections of each cell of the conventional solid oxide fuel cell.

A cell 107 is a ceramic tube in which the upper end is open and the lower end is closed (a tubular shape having a bottom). The cross section of the cell 107 has a multilayered annular shape in which an air electrode 161, an oxide layer 163, and a fuel electrode 165 are layered.

Each layer of the cell 107 has a thickness of several μm-2 mm, and is made from a ceramic material which mainly includes oxide and has necessary functions (conductivity, air permeability, oxide, electrochemical catalytic property, and the like). When an oxidizer (air, oxygen rich gas, and the like, which is referred to as “air” hereinafter) is fed into the inner surface of the cell 107 and fuel gas (H₂, CO, CH₄ and the like) is fed into the outer surface of the cell 107, O²⁻ ions move in the cell, which causes electrochemical reaction, and a potential difference is generated between the air electrode 161 and the fuel electrode 165 so as to produce electric power.

There is provided an elongated air introducing tube 104 for passing air in the cell 107. The air introducing tube 104 extends down from an air distributor 131 which is located at the upper portion of the solid oxide fuel cell, and enters the cell 107. The lower end of the air introducing tube 104 reaches near to the bottom of the cell 107, and air is supplied to the bottom of the cell 107 from the lower end of the air introducing tube 104. The supplied air goes up inside the cell 107 while contributing to the above-mentioned electric power producing reaction, and goes outside the cell 107 through the upper end of the cell 107. Finally, the air reaches an exhaust combustion chamber 137. In the exhaust combustion chamber 137, as mentioned below, the exhaust fuel gas and the exhaust air are mixed, and oxygen and fuel which have not yet been reacted in the exhaust undergo combustion.

Fuel gas is supplied to the outer surface of the cell 107 in an upward direction from a fuel supplying chamber 109 which is located at the lower portion of the solid oxide fuel cell. The supplied fuel gas goes up outside the cell 107 while contributing to the above-mentioned electric power producing reaction. The part of the fuel gas which has not yet been reacted, and electrochemical combustion reaction products (CO₂, H₂O and the like) generated in the cell enter the exhaust combustion chamber 137. Sensible heat after the combustion in the exhaust combustion chamber can be utilized for preheating air and fuel gas to be supplied to the fuel cell, or sent to an electric power generating system which employs a common steam boiler and turbine for electric power generation.

In the common solid oxide fuel cell, each cylindrical cell provides around 1 volt. Accordingly, a plurality of cylindrical cells are connected in series in order to generate a desired voltage. Specifically, taking efficiency in fabrication and maintenance into account, a cell stack 102 is typically formed in which about three cells 107 are connected in parallel, these parallel cells are connected in series by using a conductive member 108, and a current collecting member 105 is provided at both ends. In FIG. 4, the number of series connections is 6, however, the number can be adjusted in order to obtain sufficient voltage.

With regard to the electric connection relationship of the cells 107, a lot of series connections are provided in the cell stack 102 so as to obtain sufficient voltage, and a current collecting rod 141 is provided at the end of the cell stack 102 to withdraw electric power from the reaction chamber to the outside of a bulkhead 103. With this, the electric power collected by the current collecting member 105 is supplied to the outside.

In the conventional art, since the current collecting rod 141 is exposed to the outside of the reaction chamber, sealing is required to prevent fuel gas from leaking or air from entering in this area. In addition, the temperature of the reaction chamber needs to be kept around 1000° C. in order to conduct an electric power producing reaction. Accordingly, a beat insulating structure is required to reduce the leakage of heat.

Also, the current collecting member 105 is divided in the direction of the cell axis in order to relieve the thermal stress which is applied to the cell due to the difference in the coefficient of linear expansion between the current collecting member 105 and the cell. Accordingly, the number of the current collecting rods 141 is determined depending on the number of divisions of the current collecting member 105, and thus, the gas sealing structure and the heat insulating structure as mentioned above are also required to depend on the number of divisions of the current collecting member 105. As a result, the number of components is increased, which causes problems of high cost and complicated maintenance.

### DISCLOSURE OF THE INVENTION

The present invention has been made to solve the above-mentioned problems, and the object of the present invention is to provide a solid oxide fuel cell comprising cylindrical cells in which the number of the current collecting rods 141 is reduced to a minimum, and the gas sealing structure and the beat insulating structure are reduced, so as to reduce the cost and facilitate the maintenance.

According to a first aspect of the present invention, there is provided a solid oxide fuel cell comprising current collecting members which are provided at the ends of the positive pole and the negative pole respectively, each current collecting member being divided into plural sections, plural current collecting rods as a first current path which are connected to the sections of the current collecting member correspondingly, and a single current collector as a second current path to which all of the current collecting rods are connected in a reaction chamber, the single current collector withdrawing electric power from the reaction chamber.

With this, since there is only one current collecting area with respect to each of the positive pole and the negative pole, the number of the gas sealing portions can be reduced so as to facilitate the fabrication, and improve the reliability and the maintenance efficiency.

According to a second aspect of the present invention, there is provided a solid oxide fuel cell comprising current collecting members, each current collecting member being divided into plural sections, a plurality of first current paths which are connected to the sections of the current collecting member correspondingly, and a second current path to which all of the first current paths are collectively connected, the second current path withdrawing electric power from a reaction chamber, wherein the electric resistance of each first current path is substantially equal to each other.

With this, since electric current can flow uniformly by eliminating the difference in the resistance value of each rod at the time of collecting electric current, it is possible to conduct electric power generation uniformly over the direction of the cell axis, and the durability of the cells can be improved because an abnormal temperature rise is not caused by local electric power generation.

In a case of a rod having a cross section S and a length 1, the electric resistance value R can be represented by the equation R=1/Sσ (wherein a refers to conductivity). If the electric resistance value of each cell can be considered substantially equal to each other, the electric resistance of the current paths in each series direction can be made equal by adjusting the length, the cross section, or the conductivity of the member which forms the current path, as an example of the embodiment of the present invention.

### BRIEF DESCRIPTION OF DRAWINGS

FIG. 1 is a sectional view showing one embodiment of a fuel cell according to the present invention;

FIG. 2 is a perspective view showing one embodiment of the relationship between the first current paths and the second current path;

FIG. 3 is a perspective view showing another embodiment of the relationship between the first current paths and the second current path;

FIG. 4 shows an example of a fuel cell in which a conventional current collecting structure is employed; and

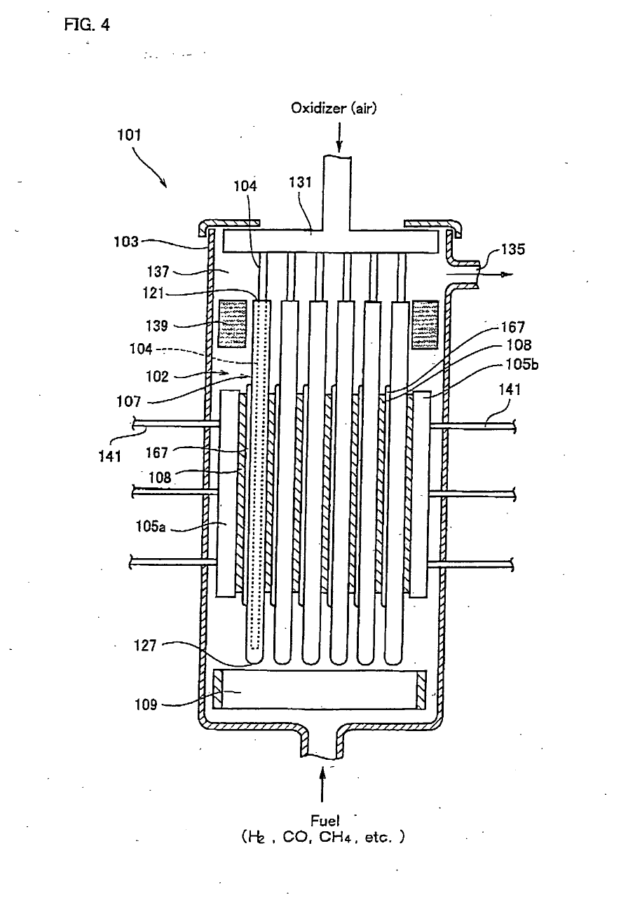

FIG. 5 shows an example of a cell of the conventional fuel cell.

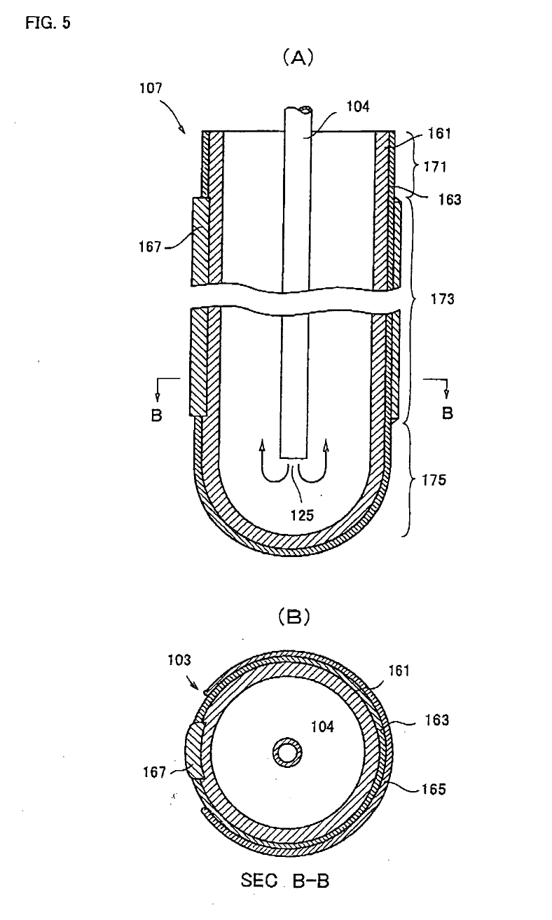

### BEST MODE FOR CARRYING OUT THE INVENTION

Hereinafter, the present invention will be den bed in more detail referring to the drawings.

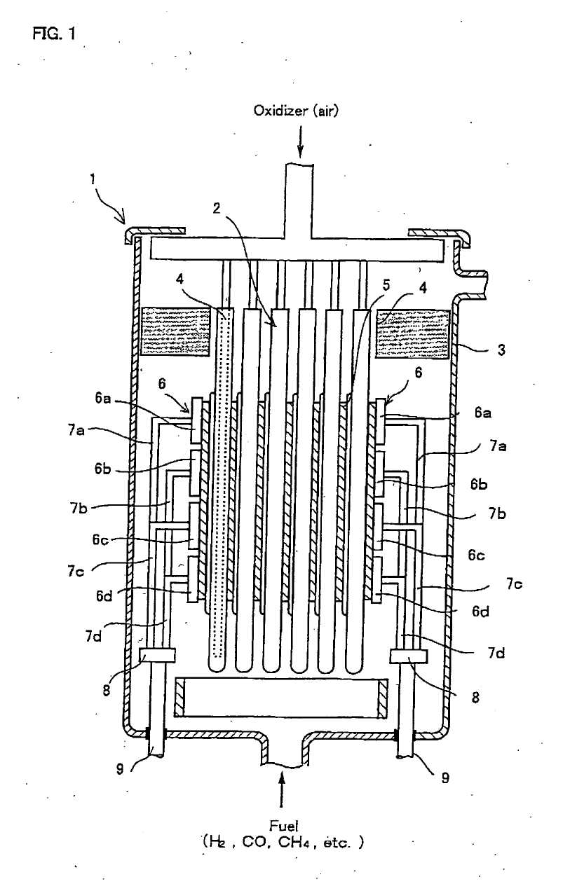

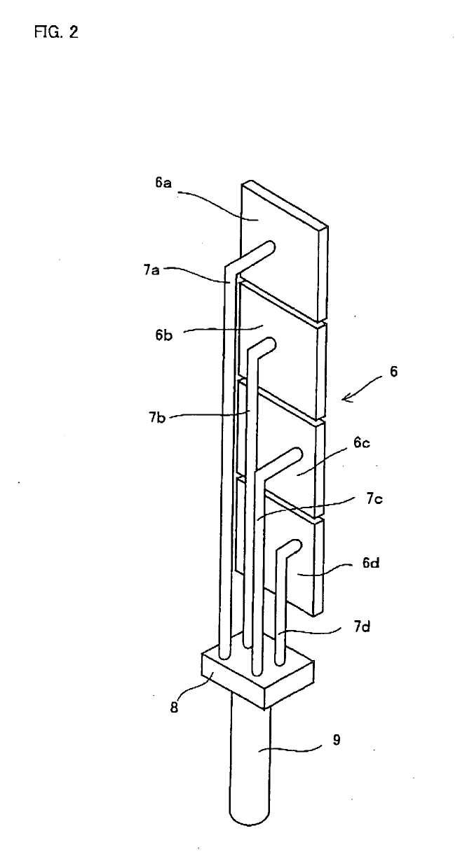

FIG. 1 is a sectional view showing one embodiment of the present invention, and FIG. 2 shows the portion to which an embodiment of the present invention is applied instead of the conventional current collecting member and the conventional current collecting rod.

A fuel cell 1 is comprised of a cell stack 2 and a bulkhead 3 which surrounds the cell stack 2. In the drawing, an example in which one cell stack 2 is accommodated within the bulkhead 3 is shown, however, it is also possible to accommodate a plurality of cell stacks 2.

In the cell stack 2, a plurality of cylindrical cells 4 are connected in a series direction and a parallel direction via a conductive member 5 such as a metal felt, The cylindrical cell 4 is comprised of a support tube, an air electrode, an oxide layer, and a fuel electrode in the same manner as the conventional art.

Incidentally, the drawing shows a case where the cell stack 2 is comprised of the cylindrical cells 4, however, the cell stack 2 may be comprised of plate-like cells.

Plate-like current collecting members 6, which are divided (into four sections) in the cell axis direction, are provided at both ends of the cell stack 2. Current collecting rods 7a, 7b, 7c, 7d as a first current path extend from the current collecting member sections 6a, 6b, 6c, 6d respectively. These current collecting rods 7a, 7b, 7c, 7d are collected at a current collector 8, and electric current is withdrawn out of the bulkhead of the reaction chamber by a terminal 9 which extends from the current collector 8. The position where electric current is withdrawn by the current collector 8 and the terminal 9 is not limited to the lower portion of the device. It may be the upper portion or the side portion.

By using the above-mentioned current collector 8 and the terminal 9, the terminal which penetrates the bulkhead of the reactor is only one with respect to each of the positive pole and the negative pole. Accordingly, a sealing structure for preventing fuel gas from leaking and a heat insulating structure which is required in a case where the terminal penetrates a heat insulator for keeping the temperature of the reaction chamber are also respectively one. As a result, it is possible to simplify the device compared to the conventional art.

Also, in a case where the current withdrawing portion is provided in the lower portion of the device as shown in FIG. 1, if the material and the cross section of the current collecting rods 7a, 7b, 7c, 7d which are respectively connected to the current collecting member sections 6a, 6b, 6c, 6d are made equal, the current collecting rod connected to the current collecting member section on the lower side is shorter than the current collecting rod connected to the current collecting member section of the upper side, and its electric resistance becomes smaller. In this instance, the electric current of the whole cell stack tends to flow through the lower portion with respect to the direction of the cell axis. Consequently, the amount of the electric power generation is decreased compared to a case, where electric power generation is conducted uniformly in all the cells. Also, since the electric power generating reaction is activated in the lower portion of the cell, the temperature rises locally in the lower portion of the cell, and thereby its durability is deteriorated.

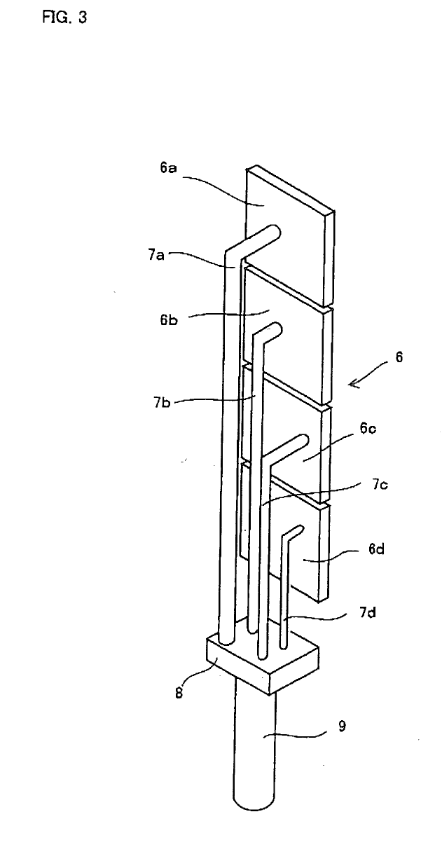

However, by adjusting the diameter (cross section) of the current collecting rods 7a, 7b, 7c, 7d which are respectively connected to the current collecting member sections 6a, 6b, 6c, 6d as shown in FIG. 3, it is possible to substantially equalize the electric resistance of the current collecting rods 7a, 7b, 7c, 7d between the Current collector 8 and the current collecting member sections 6a, 6b, 6c, 6d. With this, non-uniformity of electric current with respect to the direction of the cell axis can be prevented, and thereby electric power generation can be conducted uniformly in all the cells. As a result, it is possible to increase the amount of the electric power generation in all the cells and improve the durability and the reliability.

Also, by making the length of the current collecting rods 7a, 7b, 7c, 7d equal to each other, or by forming the current collecting rods 7a, 7b, 7c, 7d from materials having different conductivity even if the length of the current collecting rods 7a, 7b, 7c, 7d is different with each other, it is possible to equalize the electric resistance of the current collecting rods 7a, 7b, 7c, 7d.

### INDUSTRIAL APPLICABILITY

As described above, in the solid oxide fuel cell of the present invention, in the structure where electric current is withdrawn by the plurality of the current collecting rods from the current collecting member which is divided in order to relieve the thermal stress, it is possible to reduce the cost, and improve the durability and the reliability by decreasing the area which penetrates the bulkhead of the reactor.

1. A solid oxide fuel cell comprising:
current collecting members each of which is divided into plural sections in the cell axis direction;
first current paths which are connected to said sections of said current collecting members correspondingly; and
a second current path to which all of said first current paths are collectively connected in a reaction chamber, said second current path withdrawing electric power from said reaction chamber.

2. A solid oxide fuel cell comprising:
current collecting members each of which is divided into plural sections in the cell axis direction;
first current paths which are connected to said sections of said current collecting members correspondingly; and
a second current path to which all of said first current paths are collectively connected in a reaction chamber, said second current path withdrawing electric power from said reaction chamber,
wherein the electric resistance of each fist current path is substantially equal to each other.

3. The solid oxide fuel cell according to claim 1 or 2, wherein the electric resistance of each first current path connected to the current collecting members is made substantially equal to each other by adjusting any one of the length, the thickness, and the material.
